(19) United States
(12) Patent Application Publication
(10) Pub. No.: US 2025/0137867 A1
(43) Pub. Date: May 1, 2025

(54) CONTROL DEVICE

(71) Applicant: TOYOTA JIDOSHA KABUSHIKI KAISHA, Toyota-shi (JP)

(72) Inventors: Kento IWAHORI, Nagoya-shi (JP); Kazuo Fuchimoto, Anjo-shi (JP); Daiki Yokoyama, Miyoshi-shi (JP); Jyunya Katou, Toyota-shi (JP)

(73) Assignee: TOYOTA JIDOSHA KABUSHIKI KAISHA, Toyota-shi (JP)

(21) Appl. No.: 18/922,869

(22) Filed: Oct. 22, 2024

(30) Foreign Application Priority Data
Oct. 31, 2023 (JP) 2023-186494

(51) Int. Cl. G01M 3/02; G07C 5/08

(52) U.S. Cl. CPC G01M 3/02; G07C 5/0808

(57) ABSTRACT

The control device includes: an acquisition unit that acquires moving object information that is information about a moving object in a water leak inspection of a movable body that can travel by unmanned driving; and a control unit that controls at least one of a travel mode of the moving object and a control mode of the ejector according to the moving object information so that a positional relationship between the ejecting device that ejects liquid or gas to the moving object in the water leak inspection and the moving object becomes a predetermined target positional relationship.

### CROSS-REFERENCE TO RELATED APPLICATION

This application claims priority to Japanese Patent Application No. 2023-186494 filed on Oct. 31, 2023, incorporated herein by reference in its entirety.

### BACKGROUND

### 1. Technical Field

The present disclosure relates to control devices.

### 2. Description of Related Art

For example, Japanese Unexamined Patent Application Publication No. 6-34477 (JP 6-34477 A) discloses a technique for inspecting a vehicle for a water leak by spraying water onto the vehicle.

### SUMMARY

It is desired to be able to appropriately perform a water leak inspection on a moving object that travels by unmanned driving.

The present disclosure can be implemented in the following aspect.

An aspect of the present disclosure provides a control device. The control device includes:
an acquisition unit configured to acquire moving object information that is information on a moving object in a water leak inspection of the moving object, the moving object being configured to travel by unmanned driving; and a control unit configured to control either or both of a travel mode of the moving object and
a control mode of an ejector according to the moving object information in such a manner that a positional relationship between the ejector and the moving object becomes a predetermined target positional relationship, the ejector being configured to eject liquid or gas to the moving object in the water leak inspection.

With the control device according to this aspect, the travel mode of the moving object and the control mode of the ejector are controlled in such a manner that the positional relationship between the moving object and the ejector becomes the target positional relationship. It is therefore possible to appropriately perform the water leak inspection.

In the control device according to the above aspect,
the moving object information may include information for classifying the moving object.

With the control device according to this aspect, for example, the liquid can be ejected toward a target portion that is mainly inspected in the water leak inspection and that is different depending on the type of the moving object. It is therefore possible to perform an appropriate water leak inspection.

In the control device according to the above aspect,
the control mode may be at least one of the following: an ejection pressure of the liquid or the gas, an ejection amount of the liquid or the gas, and an ejection direction of the liquid or the gas.

The control device according to this aspect can control the ejection pressure, the ejection amount, and the ejection direction according to the moving object information. It is therefore possible to perform an appropriate water leak inspection.

In the control device according to the above aspect,
the control unit may be configured to set the ejection pressure or the ejection amount when a moving speed of the moving object is a first speed to a value smaller than the ejection pressure or the ejection amount when the moving speed is lower than the first speed.

The control device according to this aspect can reduce an increase in momentum of an ejection material when the ejection material ejected by the ejector collides with the moving object. It is therefore possible to perform an appropriate water leak inspection.

In the control device according to the above aspect,
the control unit may be configured to set the ejection pressure or the ejection amount when a moving speed of the moving object is a second speed to a value larger than the ejection pressure or the ejection amount when the moving speed is lower than the second speed.

The control device according to this aspect can reduce a decrease in total amount of ejection material that is ejected from the ejector to the moving object in the water leak inspection. It is therefore possible to perform an appropriate water leak inspection.

The present disclosure can be implemented in various forms. For example, the present disclosure can be implemented in the form of a moving object, an ejector, a water leak inspection system, control methods therefor, a computer program, or a recording medium having the computer program recorded thereon.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view showing a configuration of a system;

FIG. 2 is an explanatory view showing a configuration of a vehicle;

FIG. 3 is an explanatory diagram illustrating a configuration of a control device;

FIG. 4 is a flowchart illustrating a processing procedure of vehicle control;

FIG. 5 is a flow chart showing a process of controlling the ejector; and

FIG. 6 is a flowchart illustrating a processing procedure of vehicle control according to another embodiment.

### DETAILED DESCRIPTION OF EMBODIMENTS

### A. First Embodiment

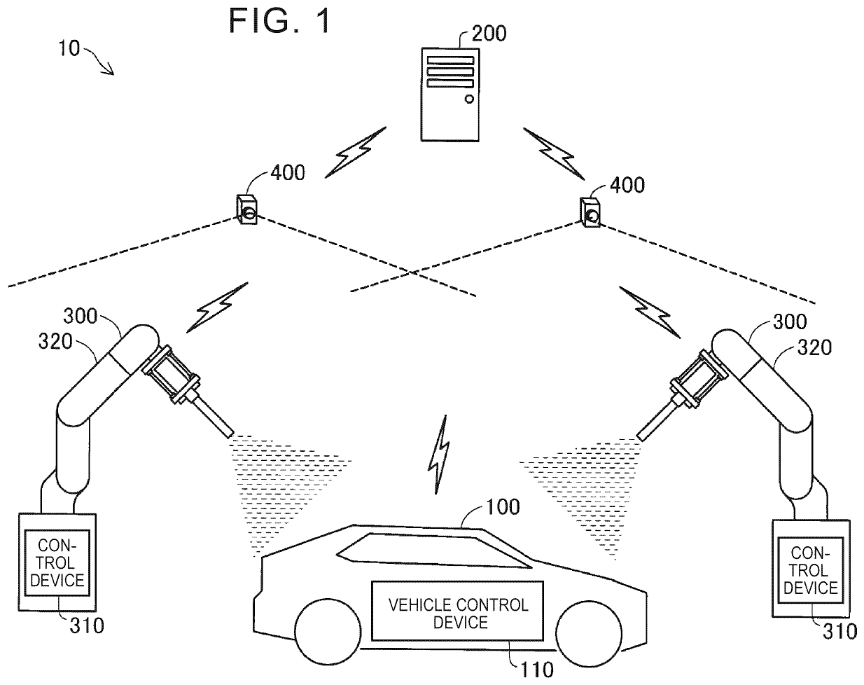

FIG. 1 is an explanatory diagram illustrating a configuration of a system 10 according to a first embodiment. The system 10 is used in a factory that manufactures the vehicle 100 as a moving object. In the present disclosure, “moving object” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include a battery electric vehicle (BEV), a gasoline-powered vehicle, a hybrid electric vehicle, and a fuel cell electric vehicle. When the moving object is other than the vehicle, the expressions of “vehicle” and “vehicle” in the present disclosure can be appropriately replaced with “moving object”, and the expression of “traveling” can be appropriately replaced with “moving”.

The system 10 includes a vehicle 100, a control device 200, an ejector 300, and at least one external sensor 400. The vehicle 100 is configured to be able to travel by unmanned driving, water leak inspection is performed by the ejector 300 on the vehicle 100 traveling by the unmanned driving. In the present embodiment, the vehicle 100 travels by unmanned driving.

In the present disclosure, “unmanned driving” means driving that does not depend on a driving operation of a passenger riding on the vehicle 100. “Driving operation” means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform a driving operation may be on the vehicle 100 traveling by the unmanned driving. The passenger who does not perform the driving operation includes, for example, a person who is simply seated in the driver's seat of the vehicle 100 or a person who performs an action different from the driving operation. The action different from the driving operation includes, for example, an assembling operation of a component to the vehicle 100, an inspection of the vehicle 100, an operation of switches provided in the vehicle 100, and the like. Driving by the driver's driving operation may be referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Also, “autonomous control” includes “full autonomous control” and “partial autonomous control”. The “fully autonomous control” allows the vehicle 100 to autonomously control its operation without receiving any information from a device external to the vehicle 100. In the “partial autonomous control”, the vehicle 100 autonomously controls its operation by using information received from a device outside the vehicle 100.

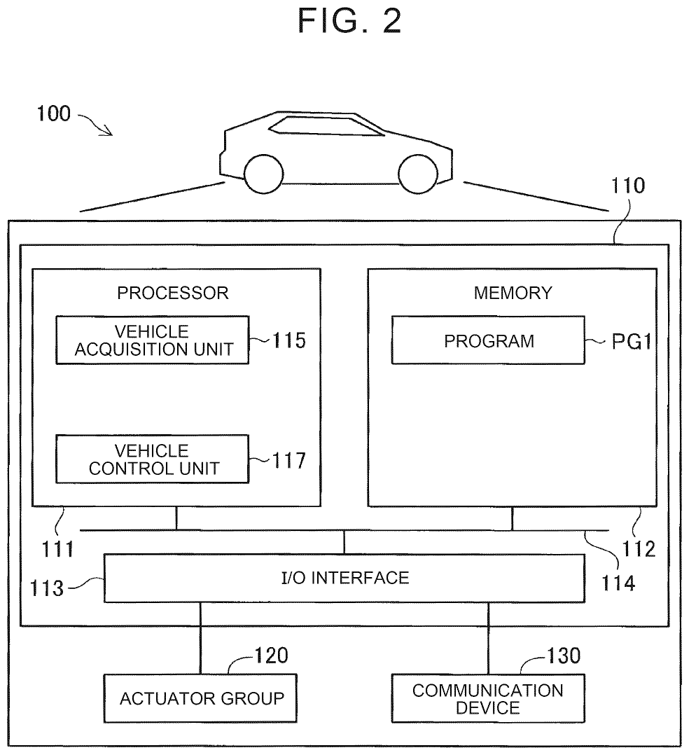

FIG. 2 is an explanatory diagram illustrating a configuration of the vehicle 100 according to the present embodiment. The vehicle 100 includes a vehicle control device 110, an actuator group 120, and a communication device 130. The vehicle control device 110 is configured to control each unit of the vehicle 100. The actuator group 120 includes at least one actuator driven under the control of the vehicle control device 110. The communication device 130 is configured to communicate with the control device 200 by wireless communication. In the present embodiment, the actuator group 120 includes an actuator of a driving device for accelerating the vehicle 100. The actuator group 120 includes an actuator of a steering device for changing the traveling direction of the vehicle 100. Further, the actuator group 120 includes an actuator of a braking device for decelerating the vehicle 100. The driving device includes a battery, a traveling motor driven by electric power of the battery, and wheels rotated by the traveling motor. The actuator of the drive device includes a traveling motor.

The vehicle control device 110 includes a computer including a processor 111, a memory 112, an input/output interface 113, and an internal bus 114. The processor 111, the memory 112, and the input/output interface 113 are bidirectionally communicably connected to each other via an internal bus 114. An actuator group 120 and a communication device 130 are connected to the input/output interface 113.

The processor 111 functions as the vehicle acquisition unit 115 and the vehicle control unit 117 by executing a computer program PG1 stored in advance in the memory 112. The vehicle acquisition unit 115 acquires a travel control signal for controlling the vehicle 100 from the control device 200. The travel control signal includes, as parameters, an acceleration and a steering angle of the vehicle 100. The travel control signal may include the speed of the vehicle 100 instead of or in addition to the acceleration of the vehicle 100. The vehicle control unit 117 controls the actuator group 120 using the travel control signal. When the occupant is on the vehicle 100, the vehicle control unit 117 can cause the vehicle 100 to travel by controlling the actuator group 120 in accordance with the driving operation of the occupant. The vehicle control unit 117 can cause the vehicle 100 to travel by controlling the actuator group 120 in accordance with the travel control signal received from the control device 200, regardless of whether or not an occupant is on the vehicle 100.

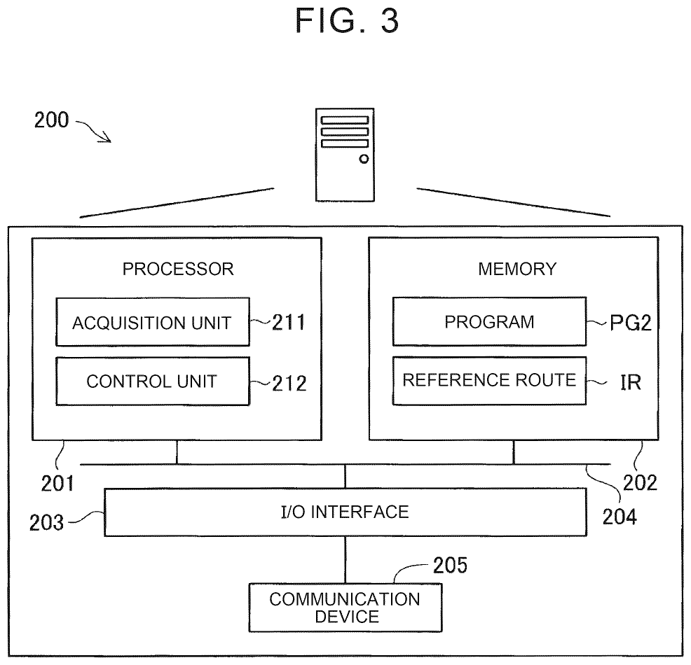

FIG. 3 is an explanatory diagram illustrating a configuration of the control device 200 according to the present embodiment. The control device 200 includes a computer including a processor 201, a memory 202, an input/output interface 203, and an internal bus 204. The processor 201, the memory 202, and the input/output interface 203 are bidirectionally communicably connected to each other via an internal bus 204. A communication device 205 for communicating with the vehicle 100 by wireless communication is connected to the input/output interface 203. In the present embodiment, the communication device 205 can communicate with the ejector 300 and the external sensor 400 by wired communication or wireless communication.

The external sensor 400 (see FIG. 1) is located outside the vehicle 100. The external sensor 400 is used to detect the position and orientation of the vehicle 100. In the present embodiment, the external sensor 400 is a camera installed in a factory. The camera as the external sensor 400 captures a captured image including the vehicle 100, and outputs the captured image as a detection result. The external sensor 400 includes a communication device (not shown) and can communicate with the control device 200 by wired communication or wireless communication. Note that the external sensor 400 is not limited to a camera, and may be, for example, a LiDAR, a millimeter-wave radar, or a sonar.

The processor 201 functions as the acquisition unit 211 and the control unit 212 by executing a computer program PG2 stored in advance in the memory 202. The acquisition unit 211 acquires moving object information related to the vehicle 100. In the present embodiment, the acquisition unit 211 acquires the moving object information using the detection result output from the external sensor 400. The moving object information includes information on the position, direction, and speed of the vehicle 100. In particular, the moving object information according to the present embodiment includes information on the position, the direction, and the speed of the vehicle 100 in the region where the water leak inspection is performed.

The control unit 212 controls the travel mode of the vehicle 100 and the control mode of the control device 200 so that the positional relationship between the vehicle 100 and the control device 200 becomes a predetermined target positional relationship in accordance with the moving object information acquired by the acquisition unit 211. The target positional relationship is a positional relationship between the ejector 300 capable of ejecting liquid and gas to a predetermined position of the vehicle 100 while traveling and the vehicle 100 in the water leak inspection. The target positional relationship is determined in advance experimentally or empirically. In the following description, a water leak inspection in which a liquid and a gas can be ejected to a predetermined position of the vehicle 100 while traveling is referred to as an appropriate water leak inspection. The liquid ejected by the ejector 300 is, for example, water. The gas ejected by the ejector 300 is, for example, air or nitrogen.

More specifically, the control unit 212 determines whether or not a predetermined condition is satisfied using the moving object information, and generates a travel control signal used for controlling the vehicle 100 in accordance with the determination result. The control unit 212 transmits the generated travel control signal to the vehicle 100. For example, the control unit 212 controls the travel mode of the vehicle 100 as follows.

Travel mode 1: When the moving speed of the vehicle 100 is higher than the inspection speed, the vehicle 100 is decelerated. Travel mode 2: When the moving speed of the vehicle 100 is slower than the inspection speed, the vehicle 100 is accelerated. Travel mode 3: The vehicle 100 is moved so that the positional relationship between the vehicle 100 and the ejector 300 becomes a target positional relationship.

The above travel modes 1 to 3 and other travel modes may be appropriately combined as a control mode.

The inspection speed in the travel mode 1 and the travel mode 2 is a target speed at the time when the vehicle 100 moves to the inspection place where the ejector 300 is disposed in the water leak inspection by the unmanned driving. The inspection speed can be determined in advance experimentally or empirically.

Further, the control unit 212 determines whether or not a predetermined condition is satisfied by using the moving object information, and generates a control signal used for controlling the ejector 300. The control unit 212 transmits the generated control signal to the ejector 300. For example, the control unit 212 controls the control mode of the ejector 300 as follows. In the present embodiment, the control mode of the ejector 300 includes an ejection pressure of the liquid and the gas to be ejected, an ejection amount of the liquid and the gas to be ejected, and an ejection direction of the liquid and the gas to be ejected.

Control mode 1: The ejection pressure or the ejection amount when the moving speed of the vehicle 100 is the first speed is made smaller than the ejection pressure or the ejection amount when the moving speed of the vehicle 100 is slower than the first speed.

Control mode 2: The ejection pressure or the ejection amount when the moving speed of the vehicle 100 is the second speed is set to be larger than the ejection pressure or the ejection amount when the moving speed of the vehicle 100 is lower than the second speed. Control mode 3: The tracking speed of the arm portion 320 to the vehicle 100 is increased in proportion to the moving speed of the vehicle 100.

By the control of the above-described control mode 1, it is possible to suppress an increase in the momentum of the ejection material ejected by the ejector 300 in the water leak inspection colliding with the vehicle 100.

By the control of the above-described control mode 2, it is possible to prevent the total amount of ejection material ejected by the ejector 300 in the water leak inspection from being reduced to be ejected to the vehicle 100.

Further, the control mode may be a control mode by appropriately combining the control mode 1, the control mode 3, or the control mode 2, the control mode 3, or other control modes.

The ejector 300 (see FIG. 1) is a device that ejects a liquid or a gas into the vehicle 100 in the water leak inspection. The ejector 300 includes a control device 310 and an arm portion 320. In the present embodiment, the control device 310 controls each unit of the ejector 300 in accordance with a control signal acquired from the control device 200. More specifically, the control device 310 controls the ejection pressure of the liquid and the gas to be ejected, the ejection amount of the liquid and the gas to be ejected, and the ejection direction of the liquid and the gas to be ejected. The arm portion 320 is constituted by a vertically articulated robot arm. Liquid and gas are ejected from the distal end of the arm portion 320. The ejector 300 includes a communication device (not shown) and can communicate with the control device 200 by wired communication or wireless communication. Note that the arm portion 320 is not limited to a vertical articulated robot arm, and may be constituted by, for example, a horizontal articulated robot arm, an orthogonal robot arm, or a parallel link robot arm.

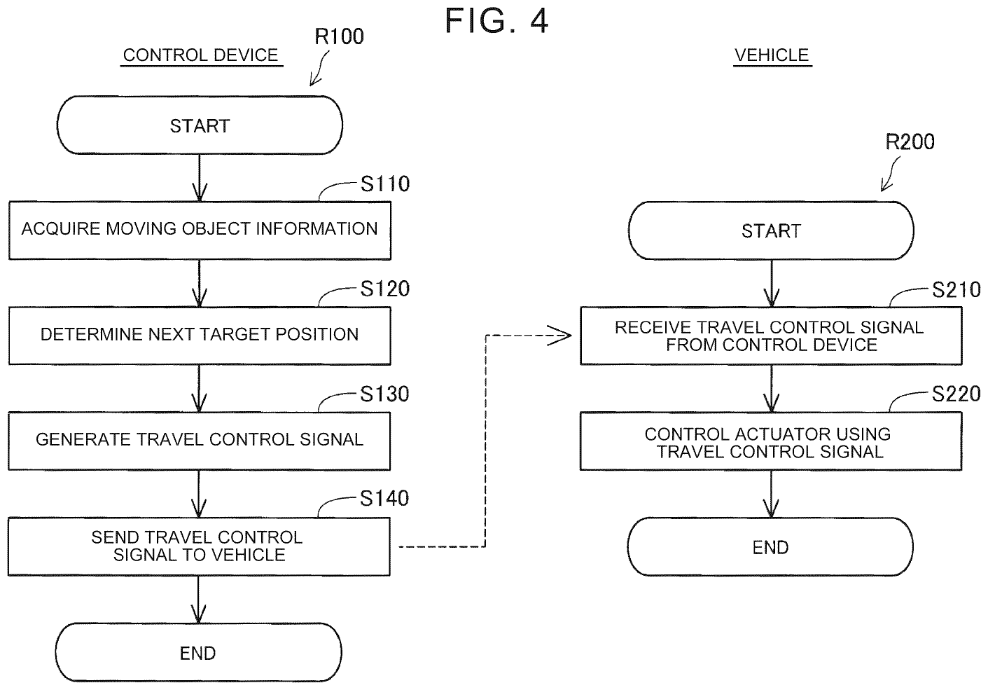

FIG. 4 is a flowchart illustrating a processing procedure of the vehicle control according to the present embodiment. The processor 201 of the control device 200 executes the first routine R100. The processor 111 of the vehicle 100 executes the second routine R200.

The first routine R100 includes S110, S120, S130, and S140. In S110, the control device 200 acquires the moving object information using the detection result outputted from the external sensor 400. In the present embodiment, the moving object information includes the position and orientation of the vehicle 100 in the global coordinate system of the factory. In the present embodiment, the external sensor 400 is a camera installed in a factory, and an image is output as a detection result from the external sensor 400. The position and orientation of the external sensor 400 are adjusted in advance. The acquisition unit 211 acquires the position and the direction of the vehicle 100 in the factory using the captured image acquired from the external sensor 400.

With respect to the method of obtaining the position of the vehicle 100, the control device 200 detects, for example, the outline of the vehicle 100 from the image. The control device 200 calculates the coordinates of the positioning point of the vehicle 100 in the coordinate system of the image, in other words, the local coordinate system of the factory.

The control device 200 can acquire the position of the vehicle 100 by converting the calculated coordinates into the coordinates in the global coordinate system. The external shape of the vehicle 100 included in the image can be detected by, for example, inputting an image into a detection model utilizing artificial intelligence. Examples of the detection model include a learned machine learning model learned to realize either semantic segmentation or instance segmentation. As the learned machine learning model, for example, a convolutional neural network (hereinafter, referred to as a CNN) learned by supervised learning in which a learning data set is inputted can be used. The training data set includes, for example, a plurality of training images including the vehicle 100 and a correct label indicating which of the regions in the training image is the region indicating the vehicle 100 and the region indicating other than the vehicle 100. When CNN is learned, the parameters of CNN are preferably updated by back propagation so as to reduce the error between the output and the correct label. Regarding a method of acquiring the orientation of the vehicle 100, the acquisition unit 211 uses, for example, an optical flow method. The acquisition unit 211 calculates a movement vector of the vehicle 100 from a change in the position of the feature point of the vehicle 100 between the frames of the image. The acquisition unit 211 can acquire the direction of the vehicle 100 by estimating the direction of the vehicle 100 based on the direction of the movement vector.

In S120, the control device 200 determines a target position to which the vehicle 100 should be heading next. In the present embodiment, the target position is represented by the coordinates of X, Y, Z in the global coordinate system. In the control device 200, a reference route on which the vehicle 100 should travel is stored in advance. The reference route is represented by a node indicating a starting point, a node indicating a passing point, a node indicating a destination, and a link connecting the respective nodes. The control device 200 uses the information indicating the position and the orientation of the vehicle 100 and the reference path to determine the target position to which the vehicle 100 should then travel. The control device 200 determines the target position on the reference route ahead of the current position of the vehicle 100.

In S130, the control device 200 generates a travel control signal for causing the vehicle 100 to travel toward the determined target position. In the present embodiment, the travel control signal includes the acceleration and the steering angle of the vehicle 100 as parameters. The control device 200 calculates the current traveling speed of the vehicle 100 from the transition of the position of the vehicle 100, and compares the calculated traveling speed with a predetermined target speed of the vehicle 100. As a whole, the control device 200 determines the acceleration so that the vehicle 100 accelerates when the traveling speed is lower than the target speed, and determines the acceleration so that the vehicle 100 decelerates when the traveling speed is higher than the target speed. When the vehicle 100 is located on the reference path, the control device 200 determines the steering angle and the acceleration so that the vehicle 100 does not deviate from the reference path. When the vehicle 100 is not located on the reference path, in other words, when the vehicle 100 deviates from the reference path, the control device 200 determines the steering angle and the acceleration so that the vehicle 100 returns to the reference path.

In S140, the control device 200 transmits a travel control signal to the vehicle 100. The processor 201 repeats the first routine R100 including acquiring the position information of the vehicle 100, determining the target position, generating the travel control signal, and transmitting the travel control signal at a predetermined cycle.

The processor 111 of the vehicle 100 executes the second routine R200 while the first routine R100 is being executed. The second routine R200 includes S210, and S220. In S210, the vehicle acquisition unit 115 receives a travel control signal from the control device 200. In S220, the vehicle control unit 117 controls the actuator group 120 by using the received travel control signal, thereby causing the vehicle 100 to travel at the acceleration and the steering angle included in the travel control signal. The processor 111 repeats the second routine R200 including the reception of the travel control signal and the control of the actuator group 120 at a predetermined cycle. According to the system 10 of the present embodiment, since the vehicle 100 can be driven by remote control, the vehicle 100 can be moved without using a conveyance facility such as a crane or a conveyor.

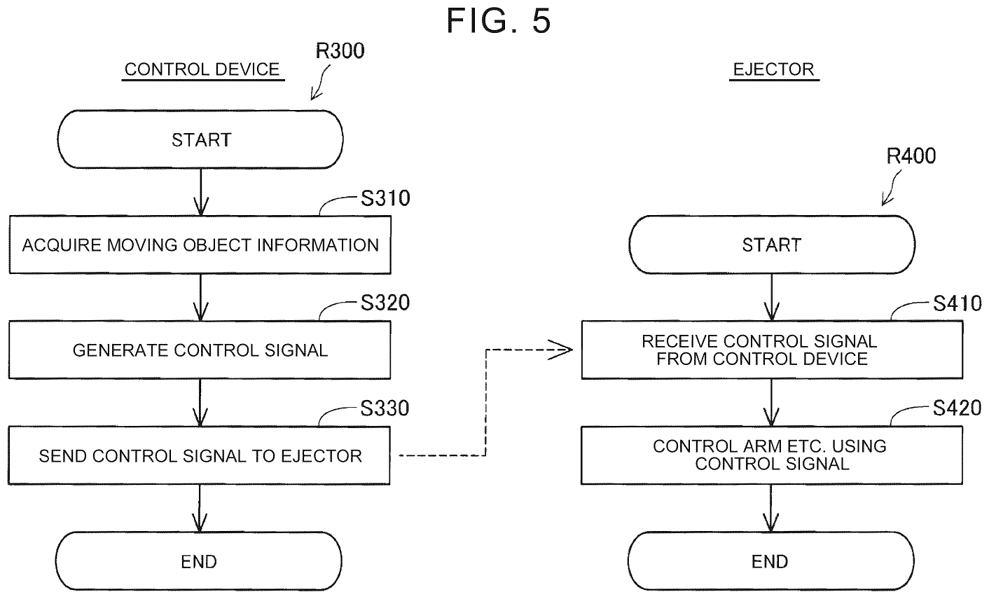

FIG. 5 is a flowchart illustrating a processing procedure of ejector control according to the present embodiment. The processor 201 of the control device 200 executes the third routine R300. The control device 310 of the ejector 300 executes the fourth routine R400.

The third routine R300 includes S310, S320, and S330. In S310, the control device 200 acquires the moving object information using the detection result outputted from the external sensor 400.

In S320, the control device 200 generates a control signal for controlling the ejector 300 in accordance with the moving object information acquired by S310. In the present embodiment, the control signal includes, as parameters, an ejection pressure of the liquid and the gas to be ejected, an ejection amount of the liquid and the gas to be ejected, and an ejection direction of the liquid and the gas to be ejected.

In S330, the control device 200 transmits a travel control signal to the ejector 300. The processor 201 repeats the third routine R300 including acquiring the moving object information, generating the control signal, and transmitting the control signal at a predetermined cycle.

The control device 310 of the ejector 300 executes the fourth routine R400 while the third routine R300 is being executed. The fourth routine R400 includes S410 and S420. In S410, the ejector 300 receives a control signal from the control device 200. In S420, the control device 310 controls the arm portion 320 using the received control signal to operate the ejector 300 so as to eject the liquid and the gas in the ejection pressure, the ejection amount, and the ejection direction included in the control signal. The ejector 300 repeats the fourth routine R400 including the reception of the control signal and the control of the arm portion 320 at a predetermined cycle.

According to the control device 200 in the present embodiment described above, since the travel mode of the vehicle 100 and the control mode of the ejector 300 are controlled so that the positional relationship between the vehicle 100 and the ejector 300 becomes the target positional relationship, it is possible to appropriately perform the water leak inspection.

Further, the control mode of the ejector 300 controlled by the control device 200 includes an ejection pressure of the liquid and the gas to be ejected, an ejection amount of the liquid and the gas to be ejected, and an ejection direction of the liquid and the gas to be ejected. Therefore, the ejection pressure, the ejection amount, and the ejection direction can be controlled in accordance with the moving object information.

### B. Second Embodiment

The second embodiment is different from the first embodiment in that the control device 200 controls the travel mode of the vehicle 100 and the control mode of the control device 200 in the case where the water leak inspection is performed again in accordance with the inspection result of the water leak inspection. Since the configuration of the system 10 according to the second embodiment is the same as that of the first embodiment, the description of the configuration of the system 10 will be omitted.

In the present embodiment, the acquisition unit 211 acquires the inspection result of the water leak inspection. The control unit 212 controls, for example, the travel mode of the vehicle 100 or the control mode of the ejector 300 as follows in a case where the water leak inspection is performed again on the vehicle 100 in which a water leak is detected in the water leak inspection.

Mode 1: The moving speed of the vehicle 100 is made slower than the moving speed in the water leak inspection in which a water leak is detected. Mode 2: The ejection pressure or the ejection amount is larger than the ejection pressure or the ejection amount in the water leak inspection in which a water leak is detected. Mode 3: The ejection direction is directed to the location where a water leak is detected.

According to the control of the above-described mode 1, in the water leak inspection again, the ejection material having a larger amount than the total amount of the ejection material ejected by the control device 200 can be ejected into the vehicle 100 than in the water leak inspection in which a water leak is detected.

By the control of the above-described mode 2, in the water leak inspection again, the momentum of the ejection material ejected by the ejector 300 colliding with the vehicle 100 can be made larger than in the water leak inspection in which a water leak is detected.

By the control of the above-described mode 3, it is possible to more carefully inspect the water leak at the location where the water leak is detected in the water leak inspection again.

Further, the above-described modes 1 to 3 and other modes may be combined as appropriate.

According to the control device 200 described above, the travel mode of the vehicle 100 and the control mode of the control device 200 in the case where the water leak inspection is performed again are controlled in accordance with the inspection result of the water leak inspection. Therefore, the water leak inspection can be performed more carefully again.

### C. Third Embodiment

The third embodiment is different from the second embodiment in that the control device 200 controls the travel mode of the vehicle 100 and the control mode of the control device 200 in the case where the water leak inspection is performed in accordance with the inspection result of the water leak inspection of the preceding vehicle. The preceding vehicle is a vehicle that travels in front of the vehicle 100. Since the configuration of the system 10 according to the third embodiment is the same as that of the second embodiment, the description of the configuration of the system 10 will be omitted.

For example, the control unit 212 controls the travel mode of the vehicle 100 or the control mode of the ejector 300 as follows when the water leak inspection of the vehicle 100 in which a water leak is detected in the water leak inspection of the preceding vehicle is performed.

Mode 1: The moving speed of the vehicle 100 is made slower than the moving speed in the water leak inspection of the preceding vehicle. Mode 2: The ejection pressure or the ejection amount is larger than the ejection pressure or the ejection amount in the water leak inspection of the preceding vehicle. Mode 3: The ejection direction is directed to the location where a water leak is detected in the water leak inspection of the preceding vehicle.

According to the control of the above-described mode 1, in the water leak inspection, the ejection material having a larger amount than the total amount of the ejection material ejected by the control device 200 can be ejected into the vehicle 100 than in the water leak inspection of the preceding vehicle in which the water leak is detected.

According to the control of the above-described mode 2, in the water leak inspection, the momentum of the ejection material ejected by the ejector 300 colliding with the vehicle 100 can be made larger than in the water leak inspection of the preceding vehicle in which a water leak is detected.

According to the control of the above-described mode 3, it is possible to more carefully inspect for a water leak at the position where a water leak is detected in the water leak inspection of the preceding vehicle in which a water leak is detected.

Further, the above-described modes 1 to 3 and other modes may be combined as appropriate.

Since there is a high possibility that the preceding vehicle and the vehicle 100 are manufactured on the same line, for example, in a case where the assembly positions of the components of the preceding vehicle are deviated in the manufacturing process, there is a possibility that the components of the vehicle 100 are deviated from each other. Therefore, when a water leak is detected in the preceding vehicle, there is a possibility that a water leak is also detected in the vehicle 100. According to the control device 200 described above, the travel mode of the vehicle 100 and the control mode of the control device 200 in the case where the water leak inspection is performed again are controlled in accordance with the inspection result of the water leak inspection of the preceding vehicle. Therefore, the water leak inspection can be more carefully performed.

### D. Other Embodiments

(D1) In each of the above-described embodiments, the control device 200 executes processing from acquisition of position information of the vehicle 100 to generation of a travel control signal. On the other hand, the vehicle 100 may execute at least a part of the processing from the acquisition of the position information of the vehicle 100 to the generation of the travel control signal. For example, the following forms (1) to (3) may be used.

(1) The control device 200 may acquire the position information of the vehicle 100, determine a target position to which the vehicle 100 should be directed next, and generate a route from the current position of the vehicle 100 represented by the acquired position information to the target position. The control device 200 may generate a route to a target position between the current location and the destination, or may generate a route to the destination. The control device 200 may transmit the generated route to the vehicle 100. The vehicle 100 may generate a travel control signal so that the vehicle 100 travels on the route received from the control device 200, and control the actuator group 120 using the generated travel control signal.

(2) The control device 200 may acquire the position information of the vehicle 100 and transmit the acquired position information to the vehicle 100. Vehicle 100 may determine a target position to which vehicle 100 should be heading next. The vehicle 100 may generate a route from the current position of the vehicle 100 to the target position represented by the received position information. The vehicle 100 may generate a travel control signal so that the vehicle 100 travels on the generated route. The vehicle 100 may control the actuator group 120 using the generated travel control signal. In each of the above-described embodiments, the vehicle operation information may be a route from the current position of the vehicle 100 to the target position.

(3) In the above forms (1) and (2), an internal sensor may be mounted on the vehicle 100, and a detection result output from the internal sensor may be used for at least one of generation of a route and generation of a travel control signal. Inner sensors may include, for example, cameras, LiDAR, millimeter-wave radars, ultrasonic sensors, GPS sensors, accelerometers, gyroscopic sensors, and the like. For example, in the form (1), the control device 200 may acquire the detection result of the internal sensor and reflect the detection result of the internal sensor in the path when generating the path. In the form (1), the vehicle 100 may acquire the detection result of the internal sensor and reflect the detection result of the internal sensor in the travel control signal when generating the travel control signal. In the form (2), the vehicle 100 may acquire the detection result of the internal sensor and reflect the detection result of the internal sensor in the path when generating the path. In the form (2), the vehicle 100 may acquire the detection result of the internal sensor and reflect the detection result of the internal sensor in the travel control signal when generating the travel control signal.

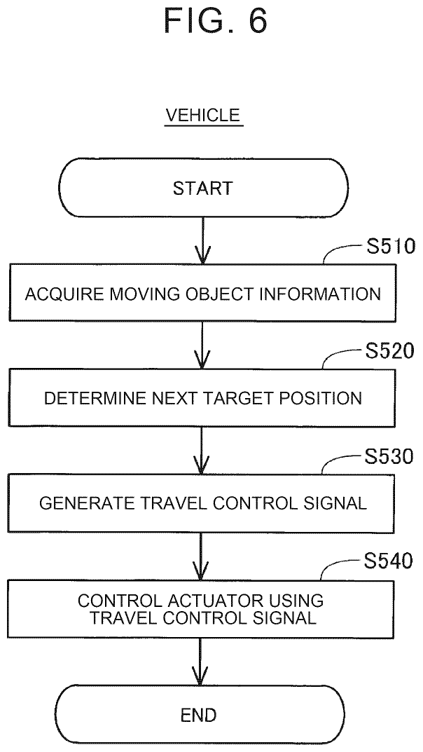

(D2) In the above-described embodiments, the control device 200 may not be provided. In this case, the information exchange between the vehicle 100 and the ejector 300 via the control device 200 described above may be directly exchanged, for example, without passing through the control device 200. In addition, the vehicle 100 may control the travel mode of the vehicle 100 itself in the water leak inspection. When the control device 200 is not provided, the processing procedure of the vehicle control is executed by the processor 111 of the vehicle 100. As illustrated in FIG. 6, in S510, the processor 111 acquires the position data of the vehicle 100 using the detection data outputted from the external sensor 400. In S520, the processor 111 determines a target position to which the vehicle 100 should be heading next. In the memory 112, a reference path is stored in advance. In S530, the processor 111 generates a travel control signal for causing the vehicle 100 to travel toward the determined target position. In S540, the processor 111 controls the actuator group 120 using the travel control signal to cause the vehicle 100 to travel at the accelerations and steering angles represented by the travel control signal. The processor 111 repeats acquisition of position information of the vehicle 100, determination of a target position, generation of a travel control signal, and control of the actuator group 120 at a predetermined cycle. In this way, the vehicle 100 can travel autonomously rather than remotely from the control device 200.

(D3) In each of the above-described embodiments, an internal sensor may be mounted in the vehicle 100, and a detection result output from the internal sensor may be used for at least one of generation of a route and generation of a travel control signal. For example, the vehicle 100 may acquire the detection result of the internal sensor and reflect the detection result of the internal sensor on the route when generating the route. The vehicle 100 may acquire the detection result of the internal sensor and reflect the detection result of the internal sensor in the travel control signal when generating the travel control signal.

(D4) In each of the above-described embodiments, the vehicle 100 acquires the position information of the vehicle 100 using the detection result of the external sensor 400. On the other hand, an internal sensor may be mounted in the vehicle 100. The vehicle 100 may acquire the position information using the detection result of the internal sensor, and determine a target position to which the vehicle 100 is to be directed next. The vehicle 100 may generate a route from the current position of the vehicle 100 to the target position represented by the acquired position information. The vehicle 100 may generate a travel control signal for traveling on the generated route, and control the actuator group 120 using the generated travel control signal. In this case, the vehicle 100 can travel without using any detection result of the external sensor 400. Note that the vehicle 100 may acquire the target arrival time and the traffic jam information from the outside of the vehicle 100 and reflect the target arrival time and the traffic jam information on at least one of the route and the travel control signal.

(D5) In each of the above-described embodiments, the control device 200 automatically generates a travel control signal to be transmitted to the vehicle 100. On the other hand, the control device 200 may generate a travel control signal to be transmitted to the vehicle 100 in accordance with a manual operation of an operator located outside the vehicle 100. For example, an operator may operate the control device, and the control device 200 may generate a travel control signal corresponding to an operation applied to the control device. The steering device may include a display, a steering, an accelerator pedal, a brake pedal, and a communication device. The display displays an image output from the external sensor 400. The steering, accelerator pedal, and brake pedal are configured to remotely operate the vehicle 100. The communication device is configured to communicate with the control device 200 by wired communication or wireless communication.

(D6) In each of the above-described embodiments, the vehicle 100 is not limited to a passenger car, and may be, for example, a truck, a bus, a construction vehicle, or the like. The vehicle 100 is not limited to a four-wheeled vehicle, and may be, for example, a two-wheeled vehicle. The vehicle 100 is not limited to being driven by wheels, and may be driven by an infinite track.

(D7) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled production, for example, at least a part of conveyance of the vehicle 100 is realized by self-propelled conveyance in a factory that manufactures the vehicle 100.

(D8) In each of the above-described embodiments, the control device 200 controls the travel mode of the vehicle 100 and the control mode of the ejector 300 in accordance with the moving object information. The present disclosure is not limited thereto, and the control device 200 may control at least one of the travel mode and the control mode.

(D9) In each of the above embodiments, the control mode of the ejector 300 includes the ejection pressure of the liquid and the gas to be ejected, the ejection amount of the liquid and the gas to be ejected, and the ejection direction of the liquid and the gas to be ejected. The control mode may include at least one of an ejection pressure of the liquid and the gas to be ejected, an ejection amount of the liquid and the gas to be ejected, and an ejection direction of the liquid and the gas to be ejected.

(D10) In each of the above-described embodiments, the control device 200 may control the control mode of the ejector 300 according to the type of the vehicle 100. For example, the control device 200 controls the ejector 300 so that the liquid is ejected toward the position associated with each type of the vehicle 100 according to the moving object information including the information for classifying the moving object. The position associated with each type of the vehicle 100 is stored in advance in the memory 202. The position associated with each type of the vehicle 100 is the position of the target portion to be inspected intensively in the water leak inspection. The target portion to be inspected intensively in the water leak inspection is, for example, a boundary portion between the door and the body of the vehicle 100. According to this mode, the control device 200 can eject the liquid toward the target portion that is different depending on the type of the vehicle 100 and that is mainly inspected in the water leak inspection. Therefore, the control device 200 can perform an appropriate water leak inspection.

(D11) In each of the above-described embodiments, the control device 200 may control the communication mode with the vehicle 100 in the water leak inspection. More specifically, the control device 200 may perform control to switch between a communication mode with the vehicle 100 during the water leak inspection and a communication mode with the vehicle 100 before the water leak inspection. The control device 200 switches, for example, a frequency band in communication with the vehicle 100 during the water leak inspection to a frequency band having greater permeability to water than a frequency band in communication with the vehicle 100 before performing the water leak inspection. According to this mode, the control device 200 can suppress the unstable communication with the vehicle 100 due to the liquid ejected by the ejector 300 in the water leak inspection.

The present disclosure is not limited to each of the above embodiments, and can be realized by various configurations without departing from the spirit thereof. For example, the technical features in the embodiments corresponding to the technical features in the respective forms described in the Summary can be appropriately replaced or combined in order to solve some or all of the above-described problems. For example, the technical features in the embodiments corresponding to the technical features in the respective forms described in the Summary can be appropriately replaced or combined in order to achieve some or all of the above-described effects. Further, when the technical features are not described as essential in the present specification, these can be deleted as appropriate.

What is claimed is:

1. A control device comprising:
an acquisition unit configured to acquire moving object information that is information on a moving object in a water leak inspection of the moving object, the moving object being configured to travel by unmanned driving; and
a control unit configured to control either or both of a travel mode of the moving object and a control mode of an ejector according to the moving object information in such a manner that a positional relationship between the ejector and the moving object becomes a predetermined target positional relationship, the ejector being configured to eject liquid or gas to the moving object in the water leak inspection.

2. The control device according to claim 1, wherein the moving object information includes information for classifying the moving object.

3. The control device according to claim 1, wherein the control mode is at least one of the following: an ejection pressure of the liquid or the gas, an ejection amount of the liquid or the gas, and an ejection direction of the liquid or the gas.

4. The control device according to claim 3, wherein the control unit is configured to set the ejection pressure or the ejection amount when a moving speed of the moving object is a first speed to a value smaller than the ejection pressure or the ejection amount when the moving speed is lower than the first speed.

5. The control device according to claim 3, wherein the control unit is configured to set the ejection pressure or the ejection amount when a moving speed of the moving object is a second speed to a value larger than the ejection pressure or the ejection amount when the moving speed is lower than the second speed.
